(19) United States
(12) Patent Application Publication
(10) Pub. No.: US 2012/0119423 A1
(43) Pub. Date: May 17, 2012

(54) METHOD AND MOULD ARRANGEMENT FOR MANUFACTURING ARTICLES WITH THE HELP OF A MOULD

(75) Inventors: Erkki Rinne, Helsinki (FI); Juha Rinne, Espoo (FI)

(73) Assignee: SILEXCOMP OY, Espoo (FI)

(21) Appl. No.: 13/320,517

(22) PCT Filed: May 11, 2010
(86) PCT No.: PCT/FI2010/050383

§ 371 Date: Jan. 27, 2012

(30) Foreign Application Priority Data
May 15, 2009 (FI) 20090194

(51) Int. Cl. B29C 43/44

(52) U.S. Cl. 264/570; 425/405.1

(57) ABSTRACT

The object of the invention is a method and a mould arrangement for manufacturing articles with the help of a mould. The solution according to the invention comprises a strong pressure-resistant frame (1) and also a pressurizing box (6) to be disposed in it, in which pressurizing box the moulds can be surrounded with high pressures and temperatures. By utilizing high temperatures, post-treatment with an autoclave is avoided. Bottom parts suited to the manufacturing technique can be disposed as the bottom part of the pressurizing box (6), in which case with the solution according to the invention techniques known from plastic mould technology, which have been used e.g. in vacuum forming moulds and injection moulding moulds, are applied to articles and moulds to be manufactured with compression moulding technology.

The present invention relates to a method as presented in the preamble of claim 1 and a mould arrangement as presented in the preamble of claim 10 for manufacturing articles with the help of a mould.

Owing to its versatility of application, the method and mould arrangement according to the invention, i.e. the solution according to the invention, is applicable to the manufacturing of many different products in the mould. In the manufacturing, various prior-art technologies and the good aspects of them are combined so that the products to be manufactured can be small or very large in size and manufactured from different raw materials, such as dung, straw, sawdust or woodchips, paper, plastic, rubber, metal, et cetera. In addition, the solution according to the invention is applicable to the rapid manufacture of very different composites.

Articles that are composed of different materials, are of different shapes or sizes, and that are otherwise different are made with the help of moulds with solutions according to prior art with many different methods, e.g. by laminating, pressing, vacuum forming, injecting, foaming and casting, and with combinations of these methods. Some articles are made by hand, some with machines designed for the purpose. Large articles are generally made manually by laminating and small articles can be pressed or cast with different methods.

Many reinforced plastic articles, i.e. plastic composites, are made according to prior art e.g. manually by laminating reinforcement material layers and resin layers in turn onto a template. The method is called open-mould lamination and one advantage of it is that also very large articles, e.g. boats, can be manufactured with it, but a problem is that open-mould lamination particularly demands professional skill, so that the quality of manufactured products can vary a lot, depending on the laminator. In addition, open-mould lamination is relatively slow. Depending on the size of the article, time ranging from a few hours to many weeks is spent on manufacturing a product. Spray-up moulding and moulding based on the vacuum bag method are reminiscent of open-mould laminating and are, to some extent, faster than it, but the variation in quality due to the high professional skill it requires and the slowness of manufacturing large articles are still a problem.

The Sheet Moulding Compound (SMC) method is used a lot, particularly in the automotive industry, for the manufacture of plastic composites. In this method hot pressing is used, which occurs as compression moulding, in which flexible SMC material that is a few millimetres thick is pressed into a mould and the preform, pressed into its shape, is cured by means of temperature. The SMC method is mainly suited to the manufacture of sheet-type moulded articles. The manufacturing time ranges from a few seconds to a few minutes, depending on the size of the article. Since moulds in prior-art solutions are extremely expensive, an economically viable series size is generally at least 10,000 units. Another problem is that the strength of articles manufactured with the SMC method is not very great.

The Bulk Moulding Compound (BMC) method is also a hot pressing method. A carefully dispensed quantity of reinforced moulding material filled with a filler agent is pressed into a mould according to the compression moulding method and cured at a higher temperature. In this method also a problem is the expensive moulds, and also the fact that the equipment used is suited only for this particular method.

Resin Transfer Moulding (RTM) is a method in which reinforcement material is placed, while dry, into an airtight two-sided mould, the second side of which is e.g. a vacuum bag. Resin is injected into the space between the moulds through the reinforcers by the aid of either underpressure or overpressure. Large articles also can be manufactured with this method, but in this case also the apparatus is suited only to this purpose. Furthermore, the curing of the resin lasts a long time.

Yet another lamination technique is prepreg lamination, which is used a lot in e.g. the aviation industry. In the prepreg method, the curing of the resin is started even before performing the lamination, but the curing time is slowed down. Prefabricated lamination sheets must be stored at a temperature of at least −18° C. so that the resin does not cure too quickly. For this reason the transportation and storage of prefabricated prepreg lamination sheets are awkward. Additionally, the epoxy resins used in prepreg methods require precise and controlled conditions for curing, e.g. a temperature of approx. 120° C.-180° C. in a pressure range of approx. 100 kg/cm². The sealing of the laminates occurs by means of a vacuum bag and post-curing requires approx. 30-60 minutes of autoclave treatment in the aforementioned temperature range.

Compression moulding, for example, in connection with injection moulding, among other things, is generally used in the manufacture by means of a mould of plastic products other than those to be laminated and of products made from other materials. Generally, however, a problem is that a vacuum or other casting techniques cannot be economically connected to compression moulding apparatus, but instead each apparatus must be separately made. In addition, it has not been possible to connect adequate heating to the compression moulding apparatus for curing the article to be manufactured, so it has only been possible to make with it certain types of articles that do not need a curing reaction.

So-called “hydroforming” technology is also known in the art, wherein by means of hydraulic pressure and a flexible film e.g. metal sheets are pressed at room temperature into a negative or a positive mould, or a combination of these. Hydroforming technology is nowadays used a lot in e.g. the automotive industry. However, the hydroforming techniques used today are not suited to simultaneously high temperatures and high compression pressures, so that e.g. plastic composite structures that require curing cannot be made with them. In addition, the mould costs of fixed moulds are relatively high in these solutions also.

One problem is that there are no devices, particularly for the manufacture of articles with large surfaces, which would comprise one apparatus that produces the pressure needed for compression and withstands the pressure as well as that produces the heat needed for curing. A problem in prior-art solutions has in this case generally been, in addition to expensive moulds, that fact that a product pressed or laminated in a mould is not immediately ready after the compression or lamination, but instead drying and/or hardening often lasts for several hours after the compression or lamination. In open-mould lamination performed by hand, in which heating is not used, articles can be detached from the mould only on the day following completion of the lamination and, in addition, detaching agents are expensive. Additionally, the autoclaves needed for curing are expensive and, being large units, also require a lot of space. Neither are there any devices in which, in connection with the manufacture of thermoplasts and thermosetting plastics, different metals and metal inserts, such as screws, various brackets or reinforcers, could be combined into the plastics. Yet another problem is that with prior-art pressing methods, e.g. with compression moulding and injection moulding, only relatively small articles can be economically manufactured, and then often only in large series.

The aim of this invention is to eliminate the aforementioned drawbacks and to achieve a method and mould arrangement for manufacturing articles with the help of a mould that are, among other things, inexpensive due to the replaceable bottom half of the pressure chamber, effective and suited to many applications. In addition, one aim of the invention is to achieve a solution in which the moulds are simple and inexpensive, but they nevertheless enable a high-quality end product. The aim is also to achieve a solution in which, among other things, the properties and good aspects of prior-art manufacturing technologies can be easily and advantageously combined, owing to the replaceable bottom half of the pressure chamber, in the manufacture of different articles of different sizes such that with one and the same basic solution large and small articles can be manufactured, and also articles currently manufactured with different technologies such as e.g. with laminating, compression, vacuum-forming, foaming and casting technologies.

The aim is also to achieve a solution with which the manufacture of different articles manufactured in a mould is faster than with prior-art technologies. Further, the aim is to save costs and shorten the time used by eliminating the need for separate autoclaving. In addition, the aim is e.g. to replace conventional vacuum technology with compression moulding, which enables the combining of injection moulding techniques and injection techniques. The method according to the invention is characterized by what is disclosed in the characterization part of claim 1. Correspondingly the mould arrangement of the invention is characterized by what is disclosed in the characterization part of claim 10. Other embodiments of the invention are characterized by what is disclosed in the other claims.

One advantage, among others, of the solution according to the invention is that the manufacturing of articles is rapid and inexpensive. Small articles are quick to manufacture in a mould, because at the same time a number of different articles can be pressed into many different moulds by means of the flexible film. Another advantage is that the moulds are inexpensive so that also small series can be economically manufactured. Inexpensive moulds also enable the mechanized manufacture of large articles and also, owing to the use of heating, even large laminated articles can be manufactured quickly and inexpensively. Separate curing treatments in expensive autoclaves are not needed.

Another advantage is that by means of the solution very many different types of products made from different materials, such as e.g. wood, metal, plastic, rubber, et cetera, can be manufactured owing to, among other things, the replaceable bottom half of the pressure chamber. Heating and compression enable, among other things, the lignin contained in wooden material to be used as a binding agent, in which case external binding agents are not always needed. In addition, another advantage is that e.g. electronics, metal inserts, such as thread elements and various fixing parts, as well as reinforcers, et cetera, can be connected to products to be manufactured from composite materials. Yet another advantage is that with the same apparatus the necessary moulds can also be manufactured, which moulds are inexpensive, light and easily installable into the pressure space. A further advantage is also that the solution according to the invention enables the production of articles currently manufactured with vacuum technology advantageously with compression moulding technology by means of the light mould structures to be manufactured. In this case it is possible in the manufacture of products manufactured conventionally with a vacuum technique to achieve the same very short manufacturing times as with conventional compression moulding technology. Likewise, in the solution according to the invention it is possible to manufacture large articles with extensive surfaces by compression moulding as well as by injection moulding and injection technology with the costs of manual lamination moulds.

In the following, the invention will be described in greater detail by the aid of some embodiments with reference to the attached drawings, wherein

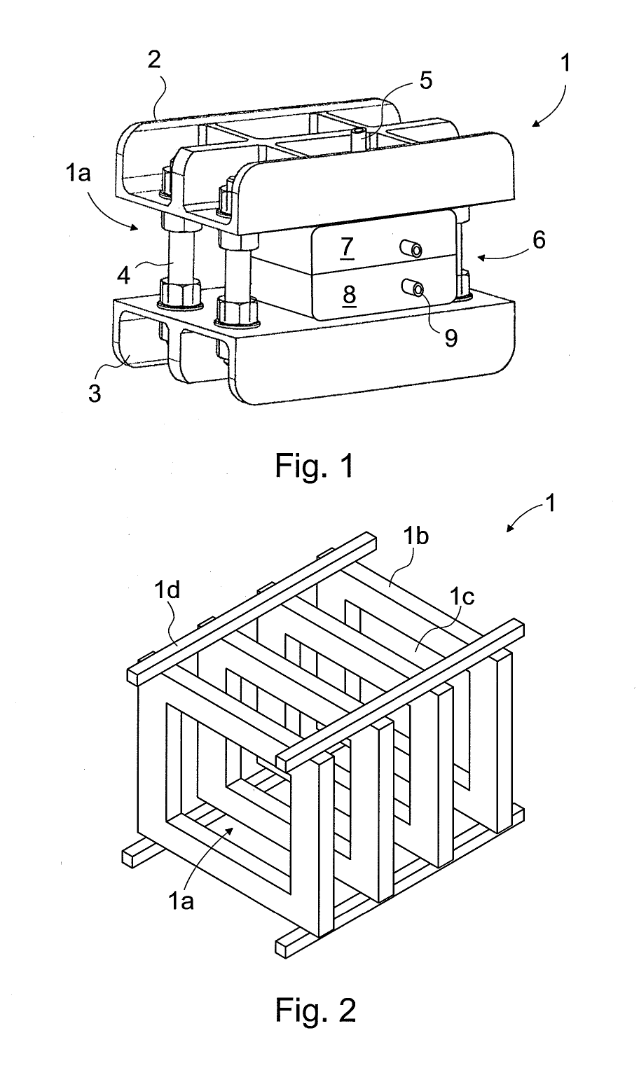

FIG. 1 presents a simplified oblique front view of one apparatus according to the invention, as viewed from above,

FIG. 2 presents a simplified oblique front view of a second apparatus according to the invention, as viewed from above,

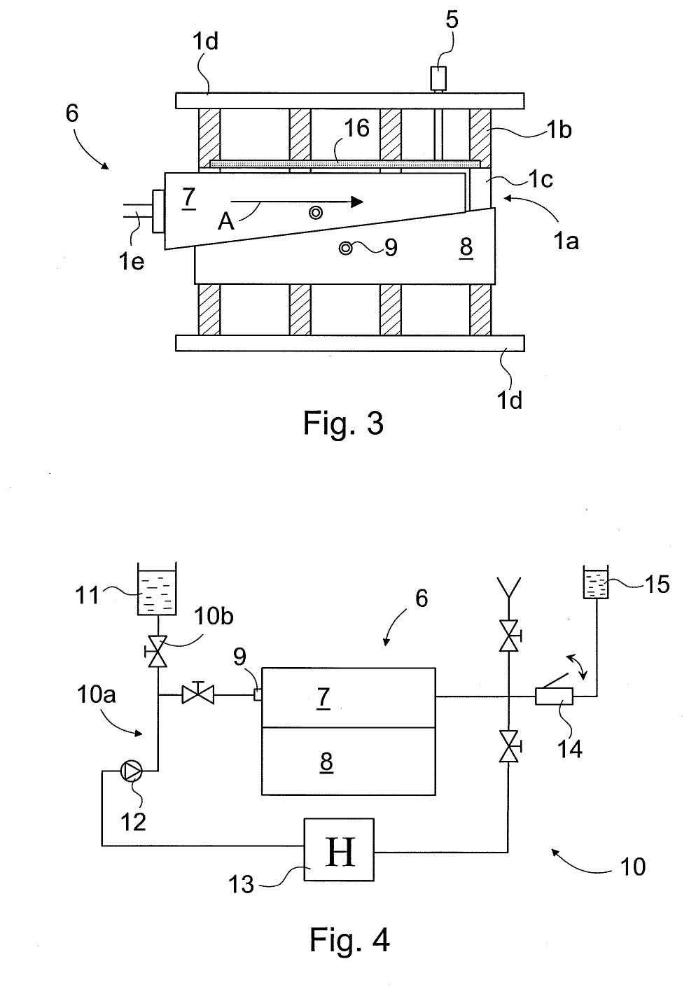

FIG. 3 presents a simplified and partially sectioned side view of the apparatus according to FIG. 2,

FIG. 4 presents a simplified and diagrammatic hydraulic scheme of the apparatus according to the invention,

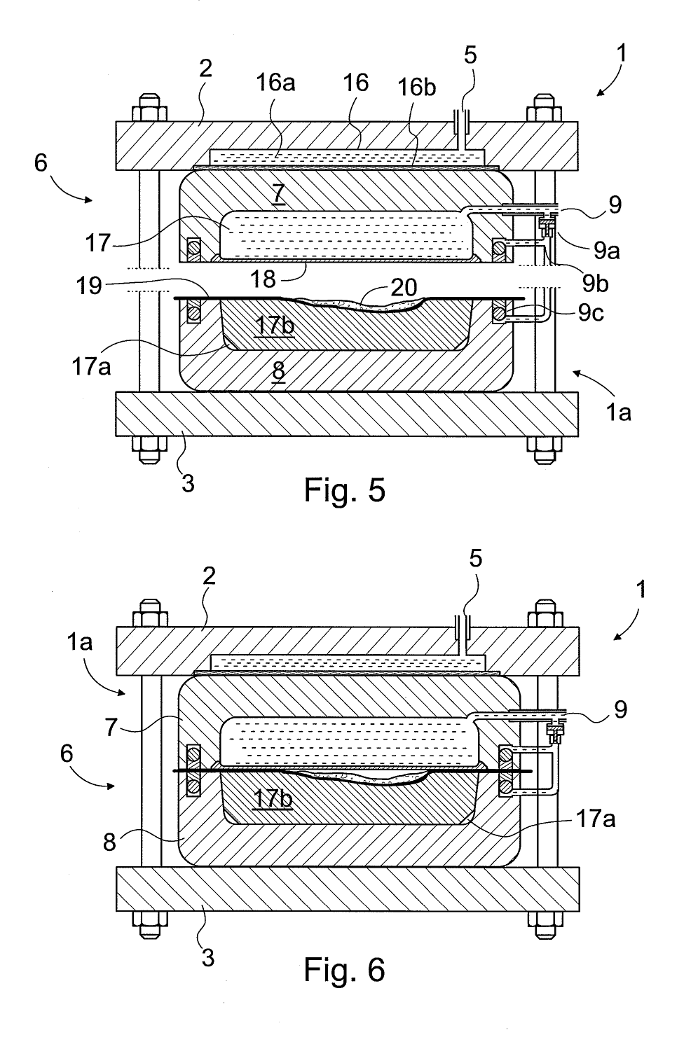

FIG. 5 presents a simplified side view of one apparatus according to the invention, sectioned and with the halves of the pressure chamber artificially separated from each other,

FIG. 6 presents a simplified side view of one apparatus according to the invention, sectioned and with the halves of the pressure chamber joined together,

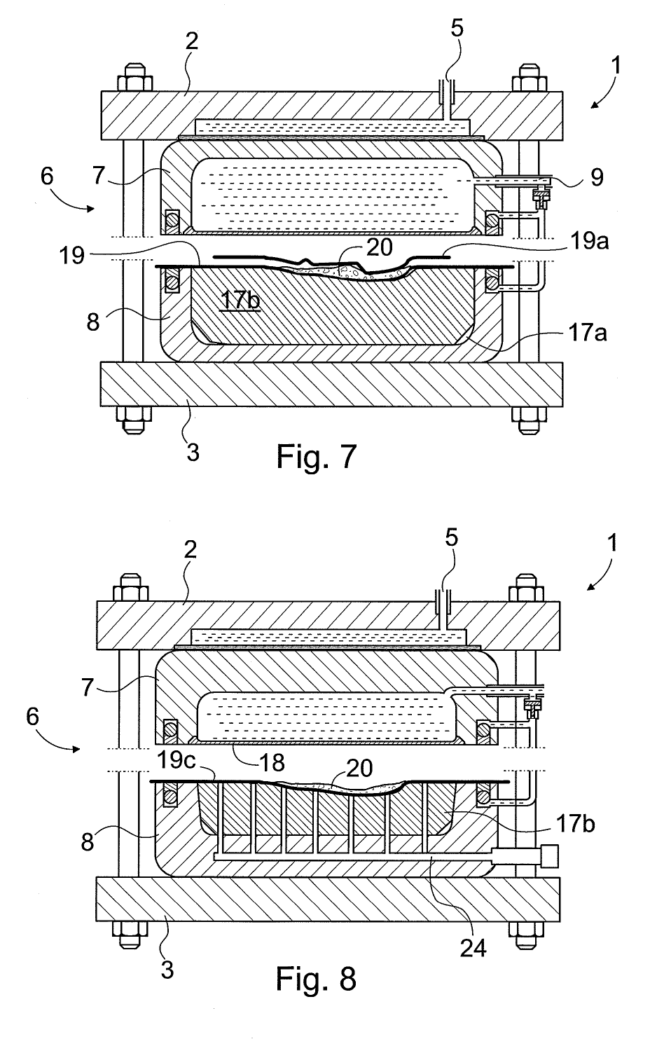

FIG. 7 presents a simplified side view of one apparatus according to the invention provided with a double mould, sectioned and with the halves of the pressure chamber artificially separated from each other,

FIG. 8 presents a simplified side view of one apparatus according to the invention, sectioned and with the halves of the pressure chamber artificially separated from each other, and provided with a lower chamber part of the pressure chamber, which lower chamber part is equipped with vacuum ducting,

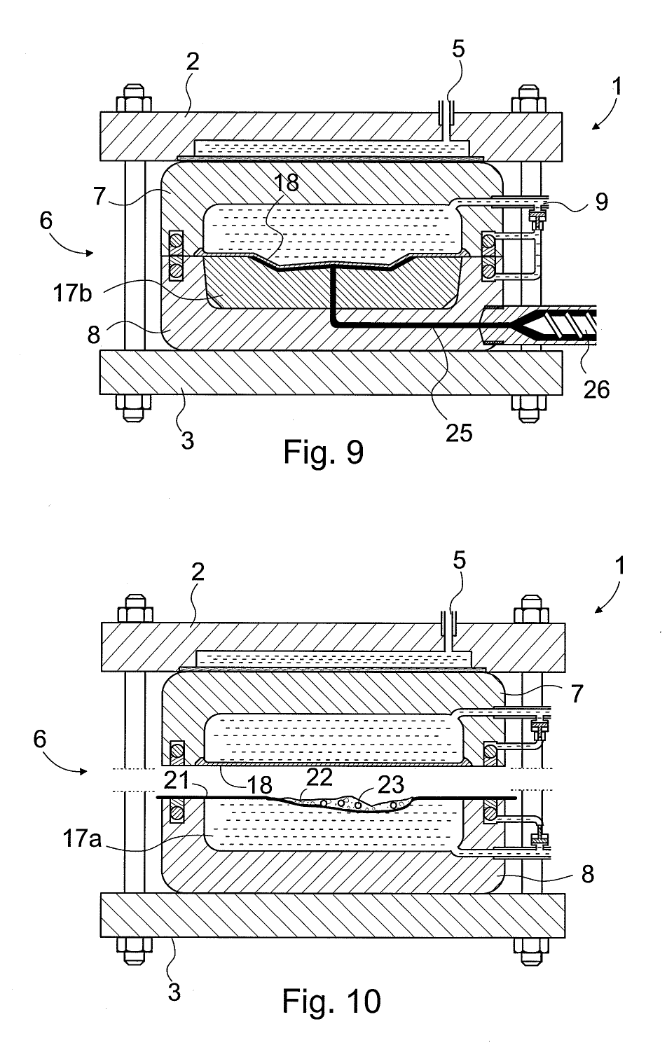

FIG. 9 presents a simplified side view of one apparatus according to the invention, sectioned and with the halves of the pressure chamber joined together, and provided with a lower chamber part of the pressure chamber, which lower chamber part is equipped with an injection moulding apparatus, and

FIG. 10 presents a simplified side view of one apparatus according to the invention for manufacturing an article of composite structure, sectioned and with the halves of the pressure chamber artificially separated from each other, and also provided with a lower chamber part of the pressure chamber, into which lower chamber part the same process pressure can be led as into the top chamber part of the pressure chamber.

A hydraulic press arrangement is used for manufacturing different products, such as products manufactured from one material as well as various composites and laminates, with different compression methods, which are e.g. compression moulding methods, vacuum forming methods and injection moulding methods. The solution according to the invention comprises a strong pressure-resistant frame 1 and also a pressure chamber 6 to be disposed inside it, in which the moulds are surrounded with high pressures and temperatures, and in which the bottom chamber part 8 of the pressure chamber 6 can be replaced according to the application at that time. The solution also comprises the utilization of high temperatures so that post-treatment with an autoclave of the products to be manufactured is avoided. With the solution according to the invention techniques known from, among other things, plastic mould technology, and which have been used e.g. in injection moulding moulds, are applied

FIG. 1 presents a simplified oblique front view of one apparatus according to the invention, as viewed from above. The apparatus is not presented in full in the figure, because for the sake of simplicity, among other things, most of the hydraulic system has been omitted from the figure. FIG. 1 shows the strong frame structure 1 of the apparatus, which frame structure comprises at least a first part, i.e. a top part, 2 and a second part, i.e. a bottom part, 3 as well as the tightening means, such as bolts 4 provided with hydraulic nuts, that connect these. With the hydraulic nuts the necessary pretightening is achieved between the top part and the bottom part 2, 3. An essentially two-piece pressure chamber 6 comprising a first chamber part, i.e. a top chamber 7, and a second chamber part, i.e. a bottom chamber 8, is disposed in the receiving space 1a between the top part 2 and the bottom part 3, which top chamber 7 and bottom chamber 8 are pressed during the manufacture of products strongly together by the aid of the top part 2 and the bottom part 3 of the frame structure as well as by the aid of the tightening means 4.

The apparatus also comprises a hydraulic compression means between the top part 2 of the frame part 1 and the top chamber 7, of which only the hydraulic connector 5 is, however, seen in FIG. 1. The compression means helps to press the top chamber 7 and the bottom chamber 8 so tightly against each other that the process pressure that is led into the pressure chamber 6 via the pressure connectors 9 and used for manufacturing a product is not squeezed out from between the top chamber 7 and the bottom chamber 8. In addition, the apparatus comprises if necessary compression means essentially corresponding to the aforementioned hydraulic compression means on one or on both sides and at one or at both ends of the pressure chamber 6 for supporting the sides and ends of the halves 7, 8 of the pressure chamber 6 as well as for limiting their movements relative to each other. Supporting the sides and the ends enables the side walls and ends of the pressure chamber to endure the stresses caused by the pressures used in all situations. These compression means are not shown in the figures.

FIG. 2 presents a simplified oblique front view of a second apparatus according to the invention, as viewed from above. This figure also presents only the basic frame structure 1 of the apparatus, which in this structural alternative comprises a plurality of robustly constructed framework-type frame elements 1b, which are disposed consecutively one after another at a horizontal distance from each other and reinforced in their position e.g. with support means 1d. In the middle of the frame elements 1b is an aperture 1c, the cross-sectional area of which is greater than the combined cross-sectional area of the top chamber and bottom chamber 7, 8. When the frame elements 1b are placed consecutively one after another, the apertures 1c are essentially in a straight line with each other and together form a receiving space 1a for the pressure chamber 6.

FIG. 3 presents a simplified and partially sectioned side view of the frame structure 1 of the apparatus according to FIG. 2. The hydraulic compression means 16 with hydraulic connector 5, which were referred to in the description of FIG. 1, can now be seen in the figure on the top surface of the receiving space. The hydraulic compression means 16 is described in more detail in connection with the description of FIG. 5. In the solution presented in FIG. 3 the structure of the top and bottom chamber 7,8 of the pressure chamber 6 differs slightly from what is presented in FIG. 1. In the solution according to FIG. 3 the long sides of the top chamber and bottom chamber 7, 8 are inclined and together form a wedge angle. In this case the first end of the top chamber 7 is higher than the second end and correspondingly the first end of the bottom chamber 8 is shallower than the second end. The wedge angles of the long sides of top chamber and bottom chamber 7, 8 are of essentially the same magnitude as each other. FIG. 3 exaggerates the magnitude of the wedge angle.

The wedge principle can also be applied such that the top surface or base of the receiving space 1a form a wedge-shaped space in relation to each other. In this case e.g. the height of the receiving space 1a decreases linearly when proceeding towards the rear end of the receiving space 1a. When viewed from the side, the receiving space 1a can in this case be such that its base is essentially on a horizontal plane but the top surface descends when proceeding from the front towards the rear end. Or the base can ascend when proceeding from the front towards the rear end whereas the top surface remains essentially on a horizontal plane. Yet a third alternative is that both the top surface descends and the base ascends when proceeding from the front towards the rear end. Correspondingly, the pressure chamber 6, with the upper chamber part 7 and lower chamber part 8 of it placed face-to-face one on top of the other, is essentially the same shape as the receiving space 1a when viewed from the side. In this case when proceeding from the front end of the pressure chamber 6 towards the rear end, either the top surface of the upper chamber part 7 descends and the base of the lower chamber part 8 remains on a horizontal plane, or the base of the lower chamber part 8 ascends and the top surface of the upper chamber part 7 remains on a horizontal plane, or the top surface of the upper chamber part 7 descends and the base of the lower chamber part 8 simultaneously ascends. In this context, the front end of the pressure chamber 6 is that end from which the pressure chamber is pushed inside the receiving space 1a and pulled out of it.

When pushing the growing wedge shape of the pressure chamber 6 into the shallowing wedge shape of the receiving space 1a, the pressure chamber 6 is finally pressed tightly between the top surface and the base of the receiving space 1a. The compression means 16 referred to in the following ensures the staying together of the compression halves.

The pressure chamber 6 is placed into the receiving space 1a of the frame structure 1 e.g. such that first the bottom chamber 8 is pushed into the receiving space 1a starting from the first end of the receiving space 1a by the aid of some suitable pushing means 1e, until the bottom chamber 8 is in its final position inside the receiving space 1a. After this the second end of the top chamber 7 is placed on top of the first end of the bottom chamber 8 and the top chamber 7 is slid by the aid of the pushing means 1e in the direction of the arrow A along the wedge surfaces between the chambers into its position on top of the bottom chamber 8. The height of the receiving space 1a as well as the combined height of the top chamber and bottom chamber 7, 8 is dimensioned such that at first there is a clearance between the top surface of the top chamber and the top surface of the receiving space 1a, but when the top chamber 7 is in its position the clearance has disappeared and the top surface of the top chamber 8 is pressed tightly against the top surface of the receiving space 1a. The final pressing of the top chamber and the bottom chamber 7, 8 against each other is implemented by means of a hydraulic compression means 16, which receives its working pressure from the hydraulic system or from a separate hydraulic aggregate, which is not presented in the figure.

FIG. 4 presents a simplified and diagrammatic hydraulic scheme of the apparatus according to the invention. The hydraulic system 10 comprises at least a pressure medium reservoir 11, pressure ducting 10a, a circulation pump 12, heating means 13 of the pressure medium, an actuator 14 that enables the process pressure into the pressure chamber 6 and a pressure medium reservoir 15 of the actuator, as well as a plurality of valves 10b. The pressures produced in the pressure chamber 6 by the compression means 16 and the actuator 14 are mutually dimensioned such that the compressive pressure prevailing in the compression means 16 is always greater than the process pressure in the pressure chamber 6.

The pressure medium is a liquid that endures high temperatures and great pressure, and which has low compressibility. It should be possible to use the pressure medium e.g. in the temperature range −40° C. . . . +450° C. One such pressure medium is e.g. a metal that melts at a low temperature, which when melted is led into the pressure chamber 6. If a temperature of the aforementioned magnitude is not needed, but instead e.g. approx. +250° C. is sufficient as a temperature, other pressure mediums can be used, e.g. ethylene glycol or corresponding substances, the compressibility of which is extremely small.

Heating of the pressure medium is implemented with heating means 13, which can be outside the pressure chamber 6, as in FIG. 4, in which case heat is produced in the pressure medium in a separate container e.g. with an electrical resistance, with induction devices or with devices operating on the microwave principle, from which container the heat is transferred along with the pressure medium to the pressure space 17 of the first, i.e. upper, chamber part 7 of the pressure chamber 6 and, depending on the solution, also to the pressure space 17a of the second, i.e. lower chamber part 8 of the pressure chamber 6. The necessary heat can also be produced inside the pressure chamber 6, e.g. in the proximity of the top surface of a ceramic mould or on the rear surface of a thin metal mould used in the invention, to which places a heat element that functions as a heating means can be disposed, which heat element operates e.g. either on the induction principle or on the resistance principle. What is essential is to get the pressure medium and/or the mould heated to the temperature needed in the manufacturing process of the product, so that the raw material used in the manufacturing can be brought to the correct temperature and/or when manufacturing laminates the hardening of the compressed product occurs quickly.

The circulation pump 12 circulates the pressure medium and the process pressure for compressing the product into its mould is implemented either manually or by means of a mechanized actuator 14 with which such great pressure is caused in the pressure chamber 6 that the article to be manufactured is pressed into essentially its final shape against the mould.

FIG. 5 presents a simplified side view of one apparatus according to the invention, sectioned and with the halves 7 and 8 of the pressure chamber 6 artificially separated from each other. The bottom surface of the top part 2 of the frame structure 1 comprises a hydraulic compression means 16, which comprises a pressure space 16a filled with pressure fluid and an elastic film element 16b that closes the pressure space from below, which film element is dimensioned to endure the pressure prevailing in the pressure space 16a. The film element 16b is fixed at its edges in a leakproof manner to the bottom surface of the top part 2. The pressure space 16a is connected to the hydraulic system 10 of the apparatus via the pressure connector 5. The film element 16b of the compression means 16 is fitted against the outer surface, i.e. the top surface, of the top chamber of the pressure chamber to press the top chamber of the pressure chamber, i.e. the upper half 7, together against the bottom chamber, i.e. the lower half 8, with a greater pressure than the process pressure prevailing inside the pressure chamber.

Inside the halves 7 and 8 of the pressure chamber 6 is a pressure space 17, 17a, which is connected to the hydraulic system 10 of the apparatus via pressure connectors 9. The pressure space 17 of the upper half 7 is closed off from the bottom part of the pressure space in a pressure-resistant manner, i.e. from the side of the lower half 8, with an elastic film 18, such as with a silicone film or Teflon film, that withstands pressure and heat. Correspondingly, the pressure space 17a of the lower half 8 comprises different elements 17b, depending on the application, manufactured from e.g. foundry sand or ceramic, which elements can fill essentially the whole pressure space 17a and rest on the base of the pressure space 17a. The mould elements 17b are made e.g. by means of foundry sand or are of ceramic and the top surface of them comprises one or more mould patterns made with the aid of a template, or the top surface of them can comprise on top of the mould pattern an essentially thin mould element with mould pattern corresponding to the mould element 19. The mould patterns in the foundry sand and the sealing of the foundry sand are done by means of the upper half 7 and the elastic film 18 as well as by means of the process pressure and a template by pressing the template into the foundry sand by the compression of the elastic film 18.

The elements 17b can function, such as they are, as moulds or as mould elements that contain a number of moulds, or a separate mould or mould element 19 can be disposed on top of them, as has been done in FIGS. 5-8. In the following a mould element refers to an entity that comprises either the mould of one large product or a number of moulds of a smaller product to be simultaneously manufactured in the same element.

Depending on the application the pressure space 17a can also be filled with pressure fluid, in which case essentially thin moulds are used between the upper and the lower half 7 and 8 of the pressure space. In this case the pressure space 17a is closed off from the top part of the pressure space, i.e. from the side of the upper half 7, with an essentially thin mould element 19, e.g. with a thin mould element that is formed into the shape of the mould of one large-sized article or the shape of the moulds of a number of small articles to be made simultaneously and that is made with a metal sheet, plastic sheet or plastic composite sheet or from another suitable material. Thus, one mould element 19 can comprise a number of similar or different mould templates for pressing a number of products at one time. When using thin moulds the lower half 8 of the pressure chamber 6 comprises means for supporting the mould element 19 in its position during filling of the mould and during manufacture of the product. Preferably these means are the edges of the lower half 8 that meet against the upper half. In this case the edges of the mould element 19 extend in the lateral direction to outside the outer edges of the lower half 8 of the pressure chamber 6, in which case when manufacturing articles the mould element 19 is pressed at its edges between the halves 7 and 8 of the pressure chamber 6.

The gap between the halves 7 and 8 of the pressure chamber 6 is sealed, e.g. with an elastic sealing means 9c, which behind the seal surface is connected via a pressure duct 9b, a pressure amplifier 9a and a pressure connector 9 to the hydraulic system 10 of the apparatus. The pressure amplifier 9a is thus connected to the process pressure and owing to its amplification ratio, which is implemented with pistons of different sizes, always causes greater pressure on the sealing means 9c than the process pressure that is prevailing at that moment in the pressure space 17, 17a of the pressure chamber 6. Thus the process pressure is not able to leak out of the pressure space 17, 17a.

The filler space that is on top of the element 17b, 19 that functions as a mould contains material 20 to be pressed into a product, which material is disposed in all the desired points on top of the mould element 17b, 19 when the lower half 8 of the pressure chamber 6 is still preferably free and outside the receiving space 1a of the frame structure 1. In this case it is easy to place all the material needed for manufacturing a product into the mould.

FIG. 6 presents an apparatus according to FIG. 5 ready to press the material 20 placed into the mould element 17b, 19 into a finished product. In the situation according to the figure, the process pressure has not yet been switched on, in which case the elastic film 18 has not yet been pressed into the mould patterns of the mould element 17b, 19. When process pressure is connected into the apparatus by means of the actuator 14, the pressure in the pressure medium in the pressure space 17 grows and the elastic film 18 is pressed tightly against the material 20 and presses it into a thin layer against the mould patterns of the mould element 17b, 19. If instead of the element 17b the pressure space 17a of the lower chamber part 8 is connected to the hydraulic system 10 of the apparatus and the pressure space 17a contains pressure medium, exactly the same pressure acts in the pressure medium in the pressure space 17a of the lower half 8 that is below, i.e. on the rear side of, the mould element 19 as in the pressure space 17 of the upper half 7 enclosed by the elastic film 18, so that the essentially thin mould element 19 withstands great process pressure without changing its shape.

FIG. 7 presents a simplified side view of one apparatus according to the invention provided with a double mould, sectioned and with the halves 7 and 8 of the pressure chamber 6 artificially separated from each other. The apparatus is otherwise essentially the same as is presented in the case according to FIG. 6 above, but now, in addition to one mould element 19, a second mould element 19a is also disposed in the compression chamber 6, which second mould element 19a is fitted on top of the lower mould element 19. The lower mould element 19 extends farther at its edges to between the halves 7 and 8 of the pressure chamber 6 or to outside the edges of them, but the upper mould element 19a is smaller in size than the lower mould element 19 and does not extend to between the halves 7 and 8 of the pressure chamber 6. There does not necessarily need to be a lower mould element 19 at all, but instead the upper mould element 19a can rest directly on the mould element 17b to be filled of the pressure space 17a.

The upper mould element 19a is also essentially thin and can be essentially similar in its material and structure to the lower mould element 19, but it can contain different mould patterns than those in the lower mould element 19 or 17b, in which case the products to be manufactured will not necessarily be of equal thickness. In this solution the elastic film 18 is pressed against the rear surface of the upper mould element 19a when the process pressure is switched on and the products are finished by pressing between the lower mould half and the upper mould half.

Each of the mould elements 19, 19a can be of such a structure that their top half and bottom half are of a different material. In this case e.g. the rear side of a mould element 19, 19a can be wholly metal whereas the front side is composite, or vice versa.

The solution according to FIG. 7 presents a pressure chamber 6 with thinner walls than in the other figures. Although no side walls are visible in FIG. 7, they are essentially as thin as e.g. the top wall and the bottom wall. The walls of the pressure chamber 6 can be even thinner yet, e.g. made by welding metal plates. In this case even very large pressure chambers can be inexpensively made. What is essential is that the walls of the pressure chamber 6 are supported externally from above, from below and from the sides, and also if necessary at the ends, such that the walls of the pressure chamber are not able to bend or bulge outwards. The supporting is performed e.g. with the aforementioned hydraulic compression means 16 and the means corresponding to them.

FIG. 8 presents one apparatus according to the invention, simplified and provided with a bottom chamber part 8 of the pressure chamber that is applicable to vacuum technology. In this case the lower chamber part 8, which is structurally solid in FIGS. 5-7 presented above, is replaced with a chamber part 8 that comprises vacuum ducting 24 fitted into the bottom chamber part 8 and into the element 17b to suck air and liquid through the mould element 19 or directly from the mould surface of the element 17b that functions as a mould, from where the vacuum ducting 24 is in connection with the vacuum machinery of the apparatus, which machinery is not shown in the figures. A thin screen 19c, with which the manufacturing material 20 is prevented from getting into the vacuum ducting 24, is between the mould surface and the manufacturing material 20 of the product. Air removal methods that are generally used in vacuum technology are used in the solution according to the invention, even though the conventional components needed for their use, such as detachment films, et cetera, are not presented in the figures.

FIG. 9 presents one apparatus according to the invention, simplified and provided with a bottom chamber part 8 of the pressure chamber that is applicable to injection moulding technology. In this case the lower chamber part 8 that is solid in its structure as presented above in FIGS. 5-7 is replaced with a chamber part 8 that comprises compression moulding ducting 25 and a compression moulding unit with screw 26 fitted into the bottom chamber part 8 and into the element 17b, with which unit the material of the product is pressed via the compression moulding ducting 25 into the mould on the top surface of the element 17b, which mould is compressed with the elastic film 18 from the side of the upper chamber part 7 of the pressure chamber 6 by means of the process pressure in the pressure space 17. In this case the manufacturing process differs from prior-art injection moulding technology, i.e. die-casting technology, in that the second sub-part of the mould is not a fixed mould, but instead is a pressure space 17, pressurized by means of hydraulics, and an elastic film 18.

FIG. 10 presents a fourth, different lower chamber part 8 of the pressure chamber 6 according to the invention. In this embodiment the lower chamber part 8 does not contain an element 17b to fill the pressure space 17a of the chamber, but instead the pressure space 17a of the chamber part 8 is filled with the pressure medium of the hydraulic system 10 of the apparatus in connection with manufacturing of the product. In this case when the product is compressed the process pressure is led to the pressure space 17, 17a of both halves 7 and 8 and, reinforced, to the sealing 9c. The solution presented in FIG. 10 is suited to e.g. the manufacturing of an article of composite structure.

The structure according to FIG. 10 could, however, just as well be such that a fixed mould element 17b is disposed in the pressure space 17a of the lower half 8 of the pressure chamber 6. In this case the process pressure is led when pressing the product into the pressure space 17 of only the upper half 7 and amplified into the seals 9c.

In the situation according to FIG. 10 the first layer 21 of a composite structure has already been pressed into a mould and the next layer 22 has been placed on top of the layer 21, which second layer comprises e.g. either reinforcing fibres, electrically conductive elements or other elements 23, which are intended to be connected to the first layer 21. When process pressure is connected to the apparatus, the elastic film 18 presses the second layer 22 with its additional elements 23 tightly against the first layer 21, and by means of great pressure and a suitable temperature the end result is one or more composite products that are quick to manufacture and durable.

The apparatus also comprises regulating means, with which the compression speed and the increase in the pressure prevailing in the pressure chamber and also the temperature prevailing in the pressure chamber are adjusted if necessary during the pressing. Correspondingly the apparatus comprises regulating means for regulating the timing of the pressurizing cycles. The regulating means are not depicted in the figures. Prior-art techniques known from e.g. injection moulding technology are used for removing air from the mould elements 17b, 19.

Characteristic to the solution according to the invention is, among other things, the heating and/or the curing of the mould element 17b, 19, 19a or of the material to be compressed that occurs by means of the liquid heating or other suitable heating as well as the formation of hydraulic pressure directly behind essentially thin mould elements 19, 19a when using thin mould elements 19, 19a. The properties of the sides of the mould elements 17b, 19, 19a that give a surface to the product are selected to be such that they withstand variations in pressure and temperature. In this case the surfaces of the mould elements 17b, 19, 19a are preferably e.g. metal or composite structures.

Further, it is characteristic to the solution according to the invention that the mould arrangement comprises a plurality of lower, i.e. second, chamber parts 8 that are provided with different properties according to the different manufacturing methods required for manufacturing different products. In this case the different chamber parts 8 can be optimally designed for exactly their own application, in which case the mould arrangement can comprise e.g. a plurality of different lower chamber parts 8, which are fitted to be used for manufacturing products e.g. by laminating, pressing, vacuum forming, injecting, foaming and casting, and with combinations of these methods and with other manufacturing methods that become relevant.

The speed of the manufacturing process of a product can be increased because a number of mould elements 19 are used. In this case the next mould element 19 can already be filled simultaneously when the previous mould element 19 is in the pressure chamber 6 in the heating phase, pressing phase, or drying/hardening phase. When the previous mould element 19 is taken out of the pressure chamber 6 to cool, the next mould element 19, which is already filled, can immediately be put inside the pressure chamber 6 and a new pressing process can be started.

With the method according to the invention, different products are manufactured by pressurizing the material to be manufactured in a pressure chamber 6 provided with a first chamber part 7 and a second chamber part 8, which second chamber part 8 is replaced according to the special properties of each product to be manufactured. In this case a plurality of chamber parts 8 that are different to each other are placed one at a time to be the second chamber part 8 as the mate of first chamber part 7, each of which chamber parts 8 differ from each other in their outfitting and/or their structure according to the special properties of the product to be manufactured with the help of each of them.

With the method according to the invention, one or more mould elements 17b, 19, 19a and the filling of the mould, i.e. the material of the article to be manufactured, are placed into the pressure chamber 6, after which the pressure chamber 6 is pushed with the aid of a pushing means 1e inside a frame structure 1 that endures the pressure needed for manufacturing the article, after which the process pressure needed for manufacturing the product is directed into the pressure chamber 6 onto at least one side of the mould by means of a pressure medium that is in liquid form. In addition to compressive pressure, the temperature in the pressure chamber 6 needed in the manufacturing process is directed at the material of the article to be manufactured and/or the article to be manufactured, which temperature is produced either via the pressure medium or by the aid of a heating means connected to the mould element 17b, 19, 19a.

According to one preferred embodiment, process pressure of essentially the same magnitude is directed on both sides of an essentially thinly structured mould element 19, 19a in the pressure chamber 6 by means of a pressure medium that is in liquid form.

The top half and the bottom half 7, 8 of the pressure chamber 6 are pressed preferably against each other with the hydraulic compression means 16 that is between the frame structure 1 and the pressure chamber 6. In addition, the sides and, if necessary, the ends of the top half and the bottom half 7, 8 of the pressure chamber 6 are supported with a compression means corresponding to the compression means 16 and to ensure the sealing, reinforced pressure from the process pressure is led to the sealing 9c that is on the joint face of the top half and the bottom half 7, 8 of the pressure chamber 6, which reinforced pressure is greater than the process pressure inside the pressure chamber 6. A metal or a metal alloy, for example, in liquid form that melts at a low temperature is led into the pressure chamber 6 as a pressure medium.

Composite structures are manufactured in one or more mould elements 17b, 19, 19a disposed in the pressure chamber 6 by placing the manufacturing material needed into the mould elements 17b, 19, 19a one manufacturing phase at a time, which material comprises e.g. plastics and reinforcing agents and, if necessary, also electronic components, metal inserts, such as thread elements and various fixing parts, as well as reinforcers, and other components needed in the finished product, and by performing the necessary pressing and heating one phase at a time.

It is obvious to the person skilled in the art that different embodiments of the invention are not limited to the example described above, but that they may be varied within the scope of the claims presented below. Thus, for example, the frame structure and the other structures of the apparatus can be different to what is described in the examples above. A supportive and strong frame structure that does not allow the halves of the pressure chamber to detach from each other is, however, essential. In this case e.g. a rock cave can also function as a frame structure.

Likewise it is obvious to the person skilled in the art that the structure of the pressure chamber can be different to what is described above. The bottom half of the pressure chamber can be e.g. shallower than the top half, and the pressure space below the mould element can be smaller than the pressure space of the top half above the elastic film.

It is further obvious to the person skilled in the art that the material of the mould elements can, in addition to the aforementioned metal, ceramic, plastic or plastic composite, also be e.g. rubber, wood, concrete or any other suitable material whatsoever that can easily be formed and that withstands the necessary pressure and temperature. The mould element can be manufactured from e.g. metal alloys, which have a low melting point, e.g. Rose's metal, tin foil and Eutectic solder. The aforementioned metal alloys are cast onto or into the template inside the pressure chamber, where the temperature is greater than the melting point of the metal in question. The metal alloy can be selected according to the temperature needed at that time. It must be noted, however, that changes in pressures and temperatures may not cause changes in the moulds, so that the moulds must not melt at the temperatures used.

It is also obvious to the person skilled in the art that the moulds can be cast from mould silicones onto or into a template in the pressure chamber e.g. with the following phase: the dispensed amount, of e.g. RTV silicone, is fed into the pressure space and vacuumized. A precise casting mould, from which copies can be made with the same principle, is obtained by pressurizing. Two-component silicone elastomer, which is cast around the mould or moulds, is advantageously utilized in connection with the mould elements. In this case the silicone layer enables the second mould half to be cheap. Likewise the silicone layer prevents sealing leaks and enables a high process pressure and operating pressure and also a high temperature.

It is also obvious to the person skilled in the art that the apparatus can comprise separate heating tanks and cooling tanks for the pressure medium that are connected to the hydraulic system of the apparatus.

It is further obvious to the skilled person that discharge routes for air and for excess material are connected to the mould elements, as also are vacuum connections for vacuum treatment.

1. Method for manufacturing articles with the help of a mould, in which method the article to be manufactured is compressed in a mould by means of a pressure medium in liquid form by pressurizing the material to be manufactured in a pressure chamber provided with a first chamber part and a second chamber part, wherein chamber parts that are different to each other are placed one at a time to be the second chamber part as the mate of first chamber part, each of which chamber parts differ from each other in their outfitting and/or their structure according to the special properties of the product to be manufactured with the help of each of them.

2. Method according to claim 1, wherein a chamber part is placed one at a time to be the second chamber part as the mate of first chamber part, which second chamber part is provided with suitable means for the purpose to apply to the manufacturing of articles to be manufactured either with laminating techniques, pressure moulding techniques, vacuum forming techniques, foaming techniques or casting techniques, or with combinations of these.

3. Method according to claim 1 or 2, wherein the material of the article to be manufactured and one or more mould elements are placed into the pressure chamber, after which the pressure chamber is fitted inside a frame structure that endures the pressure needed for manufacturing the article, which pressure chamber is pressurized by means of a pressure medium that is in liquid form.

4. Method according to claim 1, wherein in addition to the compressive pressure to be directed at the material of the article to be manufactured and/or the article to be manufactured, the temperature in the pressure chamber needed in the manufacturing process is directed at the material of the article to be manufactured and/or the article to be manufactured, which temperature is produced either by the aid of a pressure medium or by the aid of a heating means connected to the mould element.

5. Method according to claim 1, wherein the top half and the bottom half of the pressure chamber are pressed against each other with a hydraulic compression means that is between the frame structure and the pressure chamber, the pressure produced by which means is greater than the process pressure inside the pressure chamber, and in that to ensure the sealing, reinforced pressure from the process pressure is led to the sealing that is on the joint face of the top half and the bottom half of the pressure chamber, which reinforced pressure is greater than the process pressure inside the pressure chamber.

6. Method according to claim 1, wherein a metal or a metal alloy in liquid folio that melts at a low temperature is led into the pressure chamber as the pressure medium.

7. Method according to claim 1, wherein composite structures are manufactured in one or more mould elements disposed in the pressure chamber by placing the manufacturing material in the mould elements one manufacturing phase at a time, which manufacturing material comprises e.g. plastic and reinforcing agents and, if necessary, also electronic components, metal inserts, such as thread elements and various fixing parts, as well as reinforcers, and other components needed in the finished product, and by performing the necessary pressing or suction and heating one phase at a time.

8. Method according to claim 1, wherein the material of the article to be manufactured and one or more mould elements of essentially thin structure are placed into the pressure chamber, after which the pressure chamber is fitted inside a frame structure that endures the pressure needed for manufacturing the article, after which pressure of essentially the same magnitude is directed on both sides of the essentially thinly structured mould element by means of a pressure medium that is in liquid form.

9. Mould arrangement for manufacturing articles with the help of a mould, which apparatus comprises at least a frame structure and a pressure chamber provided with at least a first chamber part and a second chamber part, as well as a hydraulic system for producing the hydraulic pressure needed by the apparatus, wherein the frame structure comprises a receiving space, into which the pressure chamber a first chamber part and a second chamber part provided with at least one mould element can be disposed, placed opposite and facing each other, which second chamber part is one of a plurality of chamber parts that are different to each other, each of which chamber parts differs in their outfitting and/or in their structure from each other according to the special properties of the product to be manufactured with the help of each of them.

10. Mould arrangement according to claim 9, wherein the pressure chamber contains one second chamber part at a time as the pair of the first chamber part, which second chamber part is provided with means suited for the purpose to apply to the manufacturing of articles to be manufactured with either laminating techniques, pressure moulding techniques, vacuum forming techniques, foaming techniques or casting techniques, or with combinations of these.

11. Mould arrangement according to claim 9 or 10, wherein the apparatus comprises means for pushing the first chamber part and the second chamber part of the pressure chamber into the receiving space in the frame structure and for extracting them from the receiving space, and means for pressing the first chamber part and the second chamber part together with a force that is greater than the force brought about by the process pressure acting inside the pressure chamber during the manufacturing of a product.

12. Mould arrangement according to claim 9, wherein the interface of the first chamber part and the second chamber part comprises a sealing means provided with a pressure amplifier connected to the process pressure, the sealing pressure acting on which sealing means is always greater than the process pressure prevailing at that moment in the pressure spaces of the pressure chamber.

13. Mould arrangement according to claim 9 above, wherein inside the first chamber part is a pressure space enclosed with an elastic film and inside the second chamber part is either an essentially fixed mould element or a pressure space to be enclosed with an essentially thin mould element to be used in the manufacturing of the product, and in that the pressure space or pressure spaces are connected to the hydraulic system of the apparatus for leading the process pressure needed for manufacturing the product into the pressure spaces to one side of the mould element or to both sides of the mould elements.

14. Mould arrangement according to claim 9 above, wherein the second chamber part comprises means for supporting an essentially thin mould element in its position during filling of the mould and during manufacturing of the product, and in that the essentially thin mould element is metal, plastic, plastic composite, other suitable material, or some combination of two or more of the aforementioned materials, and in that the essentially thin mould element comprises at least one or more moulds intended for manufacturing a product to be made simultaneously.

15. Mould arrangement according to claim 9 above, wherein the apparatus comprises heating means for heating the pressure medium and/or the mould element for directing the temperature needed in the manufacturing process to the material of the product to be manufactured and/or to the product to be manufactured in the pressure chamber, and in that the heating means are partly or wholly inside or outside the pressure chamber.

16. Mould arrangement according to claim 9 above, wherein the pressure medium used in the hydraulic system of the apparatus is a metal or a metal alloy in liquid form that melts at a low temperature.

17. Method according to claim 2, wherein, in addition to the compressive pressure to be directed at the material of the article to be manufactured and/or the article to be manufactured, the temperature in the pressure chamber needed in the manufacturing process is directed at the material of the article to be manufactured and/or the article to be manufactured, which temperature is produced either by the aid of a pressure medium or by the aid of a heating means connected to the mould element.

18. Method according to claim 3, wherein, in addition to the compressive pressure to be directed at the material of the article to be manufactured and/or the article to be manufactured, the temperature in the pressure chamber needed in the manufacturing process is directed at the material of the article to be manufactured and/or the article to be manufactured, which temperature is produced either by the aid of a pressure medium or by the aid of a heating means connected to the mould element.
